(19) United States
(12) Patent Application Publication
(10) Pub. No.: US 2022/0121597 A1
(43) Pub. Date: Apr. 21, 2022

(54) DATA PROCESSING DEVICE, DATA PROCESSING METHOD, AND PROGRAM

(71) Applicant: Mitsubishi Electric Corporation, Tokyo (JP)

(72) Inventor: Osamu NASU, Tokyo (JP)

(73) Assignee: Mitsubishi Electric Corporation, Tokyo (JP)

(21) Appl. No.: 17/431,712

(22) PCT Filed: Apr. 26, 2019
(86) PCT No.: PCT/JP2019/017855

§ 371 Date: Aug. 18, 2021

(51) Int. Cl. G06F 13/40; G06F 9/48

(52) U.S. Cl. CPC G06F 13/4068; G06F 9/48

(57) ABSTRACT

A data processing device (1) includes a data collector (11) to collect data from a machine (4), data processors (12) to individually execute predetermined data processing, an execution controller (14) to control transmission and reception of data between the data collector (11) and each of the data processors (12), and between the data processors (12), in accordance with setting information for a predetermined data processing flow, and interfaces provided in the data processors (12) and the execution controller (14), respectively, and configured to transmit and receive data and definition information on the data to and from each other.

### TECHNICAL FIELD

The present disclosure relates to a data processing device, a data processing method, and a program.

### BACKGROUND ART

In the field of factory automation, some data processing devices collect data from factory automation (FA) machines in a manufacturing factory and execute a series of data processing, such as modification and diagnosis, on the collected data in the order defined in a processing flow. Unfortunately, the existing data processing devices have various specifications different among corporations. This situation makes it difficult to establish a general-purpose system.

Another attempt has been made in recent years to establish a data processing device by accumulating data processing modules on the common platform. Demanded is free replacement of various data processing modules, such as modification and diagnosis, to extend the data processing flow.

Patent Literature 1 discloses a technique of requesting a data processing unit to execute data processing in accordance with a workflow and thus achieve a series of data processing. A request destination determination unit, which requests a data processing unit not defined in the workflow, refers to a list including identification information for identifying a process not defined in the workflow. In the case where the list includes identification information contained in setting information input by a user, the request destination determination unit issues a request for data processing to the data processing unit that executes the process associated with the designated identification information. This configuration can achieve execution of a process not defined in the workflow using setting information input during execution of the workflow, without preliminarily definition of a coordinated workflow.

### CITATION LIST

### Patent Literature

Patent Literature 1: Unexamined Japanese Patent Application Publication No. 2009-146092

### SUMMARY OF INVENTION

### Technical Problem

In the technique disclosed in Patent Literature 1, the combination of data processing modules can be flexibly changed. This technique, however, does not involve later addition of another data processing module, which is a candidate to be incorporated into the combination. That is, no data processing module is allowed to be added by a user manipulation, and the data processing modules to be incorporated into the combination must be installed in advance. This configuration cannot satisfy a possible requirement of a product manufacturer for additional installation of a data processing module.

An objective of the disclosure, which has been accomplished in view of the above situations, is to achieve later addition of a data processing module and flexible change of the combination of data processing modules.

### Solution to Problem

In order to achieve the above objective, a data processing device according to an aspect of the disclosure includes: a data collector to collect data from a machine; data processors to individually execute predetermined data processing; an execution controller to control transmission and reception of data between the data collector and each of the data processors, and between the data processors, in accordance with setting information for a predetermined data processing flow; and interfaces provided in the data processors and the execution controller, respectively, and configured to transmit and receive data and definition information on the data to and from each other.

### Advantageous Effects of Invention

According to an aspect of the disclosure, later addition of a data processing module and flexible change of the combination of data processing modules can be achieved by transmission and reception of definition information on data.

### BRIEF DESCRIPTION OF DRAWINGS

FIG. 1 illustrates a configuration of a data processing system according to an embodiment of the disclosure;

FIG. 2 illustrates a functional configuration of a data processing device according to the embodiment;

FIG. 3 illustrates a configuration of an engineering tool according to the embodiment;

FIG. 4 illustrates a hardware configuration of the data processing device according to the embodiment;

FIG. 5 illustrates an example of a data processing flow according to the embodiment;

FIG. 6 illustrates an example of flow setting information according to the embodiment;

FIG. 7 illustrates a communication configuration between a data processor and an execution controller according to the embodiment;

FIG. 8 is a flowchart illustrating operation steps of the execution controller according to the embodiment;

FIG. 9 is a flowchart illustrating operation steps of the data processor according to the embodiment; and

FIG. 10 illustrates a communication configuration between the data processor and the execution controller via an MQTT broker according to the embodiment.

### DESCRIPTION OF EMBODIMENTS

A data processing device, a data processing method, and a program according to an embodiment of the disclosure will now be described in detail with reference to the accompanying drawings.

### Embodiment 1

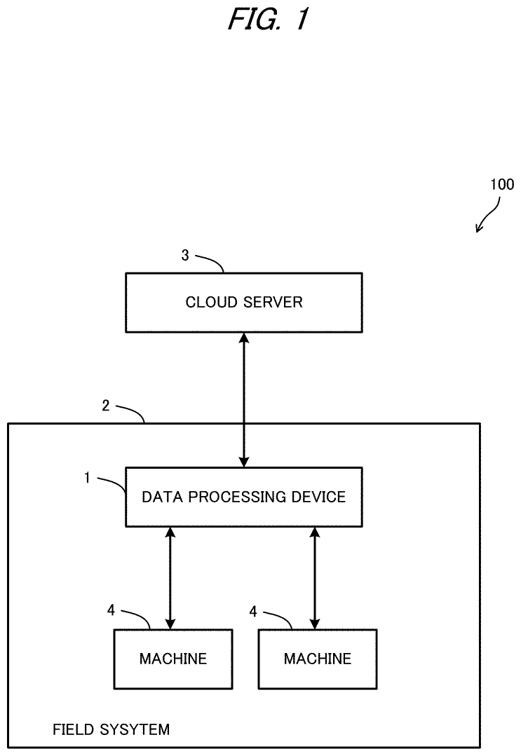

FIG. 1 illustrates a configuration of a data processing system 100 including a data processing device 1 according to an embodiment of the disclosure. The data processing system 100 is used in the field of FA. The data processing system 100 executes data processing on data collected from various machines and controls the machines on the basis of the data processing.

The data processing system 100 includes a field system 2 installed in a factory for manufacturing products, and a cloud server 3 connected to the field system 2. It should be noted that the cloud server 3 is not an essential component, and the field system 2 may exist alone.

The field system 2 is equipped with machines 4, such as a production machine, sensor, and driving machine, and the data processing device 1 connected to the machines 4 to collect data from the machines 4.

The data processing device 1 is an edge device installed in a manufacturing factory located in the edge computing area between the area of FA machines and the cloud. The data processing device 1 picks up data from the machines 4, executes modification and diagnosis on the data, and returns the data to the machines 4. When this process is executed by the cloud server 3 at a remote site, the processing takes a long time. In order to solve this problem, the real-time data processing is assigned to the data processing device 1. This configuration can avoid a delay in the real-time data processing and optimize the amount of data to be transmitted to the cloud server 3.

The data processing device 1 is an industrial computer installed in the factory. The data processing executed by the data processing device 1 corresponds to the control for operating a production line that manufactures products.

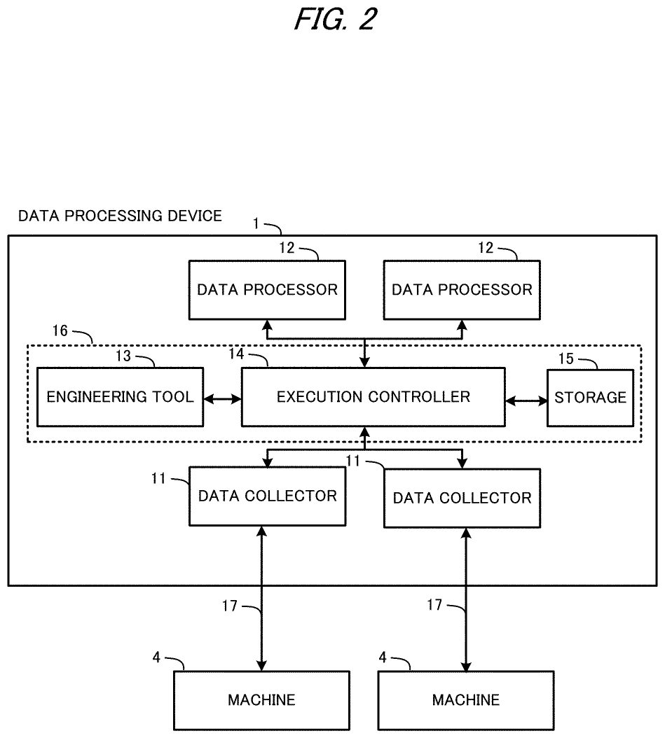

As illustrated in FIG. 2, the data processing device 1 includes data collectors 11 to collect data from the machines 4, data processors 12 to execute various data processing on the collected data, an engineering tool 13 to set a below-described data processing flow, an execution controller 14 to control the execution of data processing in accordance with the data processing flow, and a storage 15 to store various types of data.

The engineering tool 13, the execution controller 14, and the storage 15 constitute a platform 16 for execution of the data processing flow. The platform 16 can contribute to ready change of the individual functions in a series of functional processing including collection of data, modification, diagnosis, and feedback.

The series of real-time data processing is configured by combining collection of data, modification, diagnosis, and feedback, for example. Examples of the modification of data include smoothing, sharpening, and fast Fourier transform (FFT) of data. Examples of the diagnosis of data include determination using a threshold and pattern matching. The feedback indicates a notification of the diagnosis result. A typical example of the feedback is writing of an instruction to stop, decelerate, or restart machines in the manufacturing factory. Such a combination of processing modules is called a data processing flow.

The engineering tool 13 sets setting information for the data processing flow, which indicates setting items necessary for execution of the data processing flow. The setting information for the data processing flow will be hereinafter referred to as “flow setting information” as appropriate. Using the engineering tool 13, a user sets a combination and execution order of the data processors 12, and a type and format of data to be transmitted and received between the data processors 12 and the data collectors 11.

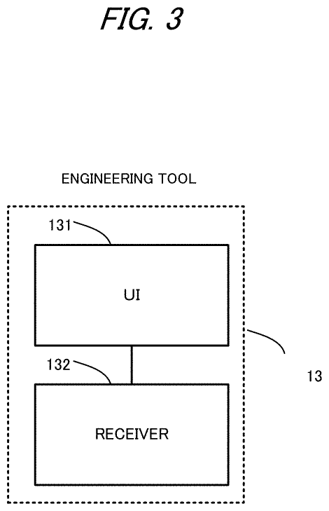

As illustrated in FIG. 3, the engineering tool 13 includes a user interface (UI) 131 to allow the user to input setting items for the data processing flow, and a receiver 132 to receive the setting items for the data processing flow. The UI 131 displays a screen for input of setting items for the data processing flow to the user, under the control by the receiver 132. The user manipulates the UI 131 and thereby arbitrarily sets the contents and number of the subprocesses constituting the data processing flow, parameters necessary for execution of the subprocesses, and the data processors 12 to execute the subprocesses. The UI 131 then outputs information, which indicates the setting items for the data processing flow input by a manipulation of the user, to the receiver 132. The UI 131 may also be configured by a display, a keyboard, and a pointing device represented by a mouse.

The receiver 132 receives the setting items for the data processing flow from the UI 131, and notifies the execution controller 14 of the flow setting information indicating the received setting items. The flow setting information provided to the execution controller 14 is stored into the storage 15.

The data processors 12 are achieved by a program preliminarily installed in the data processing device 1 or plug-in software prepared by the user. Each of the data processors 12 executes a subprocess, which is a component constituting the data processing flow. In detail, the data processor 12 acquires the data, input from the execution controller 14, to be subject to a subprocess, and outputs the result of the subprocess on the acquired data to the execution controller 14.

The execution controller 14 causes the data processors 12 and the data collectors 11 to execute the subprocesses in the order in accordance with the flow setting information. In detail, the execution controller 14 acquires data to be subject to a subprocess from the data processors 12 and the data collectors 11, and outputs the acquired data to the data processor 12 or the data collector 11 that executes the subprocess on the data.

The storage 15 stores the flow setting information, and definition information on the data transmitted and received between the execution controller 14 and the data processors 12.

The data collectors 11 collect data output from the machines 4 and output the collected data to the execution controller 14.

The data collectors 11 and the machines 4 are connected so as to communicate with each other via communication paths 17. The communication paths 17 correspond to an industrial control network configured by communication lines installed in the factory. The communication paths 17 may also be an information network represented by a local area network (LAN). Alternatively, the communication paths 17 may be dedicated lines or a wide area network represented by the Internet.

The machines 4 are FA machines, for example, a sensor, assembly robot, driving machine, and programmable logic controller (PLC) to control another machine, such as a sensor or assembly robot. The data processing device 1 transmits information for requesting various types of data and control information to the machines 4. The machines 4 then provide the data processing device 1 with the requested data in response to the request from the data processing device 1, or various types of data, such as measurement data from a sensor, at predetermined timings.

The data collectors 11 transmit output information. The output information is related to results of execution of the data processing flow. For example, the data collectors 11 transmit control commands output from the execution controller 14 to the machine 4 to be controlled, in the form of the output information. The output information is not necessarily be the control commands and may be a notification of occurrence of an error or quality-control information to be stored into an external server apparatus.

The data processors 12 are configured by applications. The applications accumulated on the common platform 16 can form the data processing device 1.

The data processing device 1 executes a series of real-time data processing that involves collecting data from the manufacturing factory, and feeding data, such as a stop instruction, back to machines in the manufacturing factory on the basis of the results of data processing, such as modification, analysis, and diagnosis.

The data processors 12 are generated by a bender, which is a third party. The machines 4 have various specifications different among manufacturing factories. That is, the data processors 12, which process data collected from the machines 4 and feed appropriate data back to the individual machines 4, must be designed appropriately for each manufacturing factory. In this case, required is a connecting mechanism between the platform 16 and the data processors 12 so as to achieve flexible processing at the data processors 12 depending on collected data.

This requirement is satisfied by interfaces defined between the execution controller 14 constituting the platform 16 and the data processors 12. The execution controller 14 and the data processors 12 have functions of transmitting and receiving data by means of the interfaces.

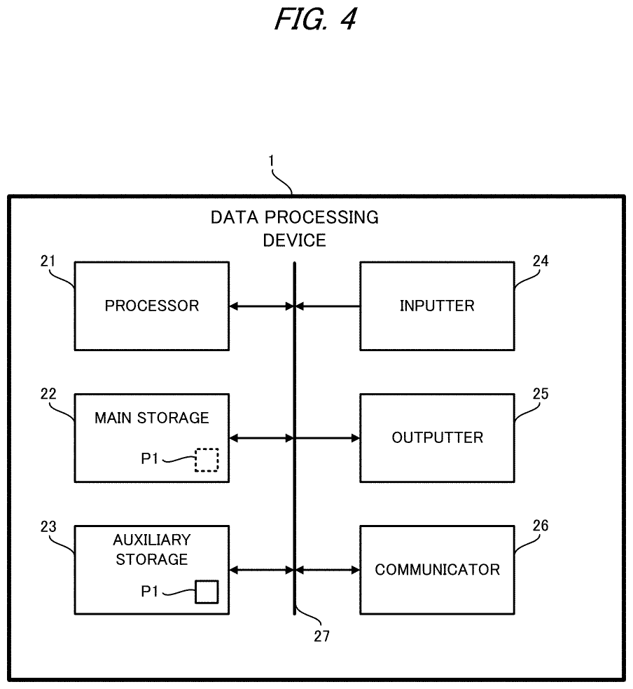

As illustrated in FIG. 4, the data processing device 1 has a hardware configuration including a processor 21, a main storage 22, an auxiliary storage 23, an inputter 24, an outputter 25, and a communicator 26. The main storage 22, the auxiliary storage 23, the inputter 24, the outputter 25, and the communicator 26 are each connected to the processor 21 via internal buses 27.

The processor 21 includes a central processing unit (CPU). The processor 21 executes a program P1 stored in the auxiliary storage 23 and thereby performs various functions of the data processing device 1.

The main storage 22 includes a random access memory (RAM). The program P1 is loaded from the auxiliary storage 23 into the main storage 22. The main storage 22 serves as a work area of the processor 21.

The auxiliary storage 23 includes a non-volatile memory, represented by an electrically erasable programmable read-only memory (EEPROM) or a hard disk drive (HDD). The auxiliary storage 23 stores the program P1 and various types of data used in processes in the processor 21. The auxiliary storage 23 provides the processor 21 with the data to be used by the processor 21 and stores data fed from the processor 21 under the instructions from the processor 21. Although FIG. 4 illustrates a single program P1 as a representative, the auxiliary storage 23 may store multiple programs, and the programs may be loaded into the main storage 22.

The inputter 24 includes an input device, represented by an input key or pointing device. The inputter 24 acquires information input by a user of the data processing device 1 and provides the acquired information to the processor 21.

The outputter 25 includes an output device, represented by a liquid crystal display (LCD) or speaker. The outputter 25 presents various types of information to the user under the instructions from the processor 21.

The communicator 26 includes a network interface circuit to communicate with external apparatuses. The communicator 26 receives signals from the outside and outputs data indicated by the signals to the processor 21. The communicator 26 also transmits signals indicating the data output from the processor 21 to external apparatuses.

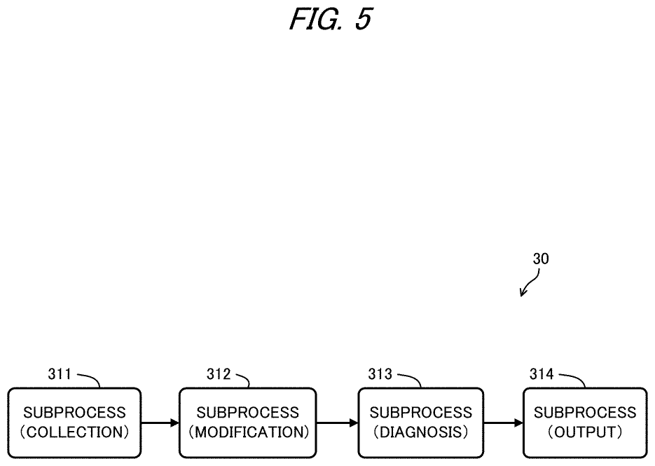

FIG. 5 illustrates an example of a data processing flow 30 executed by the data processing device 1. The data processing flow 30 involves a series of subprocesses directed to the data collected from the machines 4.

A subprocess 311 corresponds to a process of collecting data from the machines 4 executed at the data collector 11, and a subprocess 312 corresponds to a process of modifying data output as a result of the subprocess 311 executed at the data processor 12. Examples of the process of modifying data include reducing noise and treating fractions.

The execution controller 14 acquires the data, collected as a result of the subprocess 311, from the data collector 11, and then outputs the acquired data to the data processor 12 that executes the subprocess 312. The execution controller 14 also acquires the data, output as a result of the subprocess 312, from the data processor 12, and then outputs the acquired data to another data processor 12.

A subprocess 313 corresponds to a process of diagnosing the data, output as a result of the subprocess 312, executed at the data processor 12. Examples of the process of diagnosing data include determining control commands directed to the machines 4 and determining the existence of errors.

The execution controller 14 outputs the data, which indicates the diagnosis result output as a result of the subprocess 313, to the data collector 11 that executes a subprocess 314.

The subprocess 314 corresponds to a process of outputting the data, which indicates the diagnosis result output as a result of the subprocess 313, to the outside. A typical example of the process of outputting the diagnosis result is transmitting the control commands to the machine 4. The data collector 11 transmits the diagnosis result to the machine 4.

In accordance with the data processing flow 30 illustrated in FIG. 5, the series of processing involving the subprocesses 311, 312, 313, and 314 is executed in response to every output of measurement results from the machine 4. The details of control for the machine 4 are then determined depending on the value after reduction of noise from the measurement results, followed by transmission of the control commands, for example.

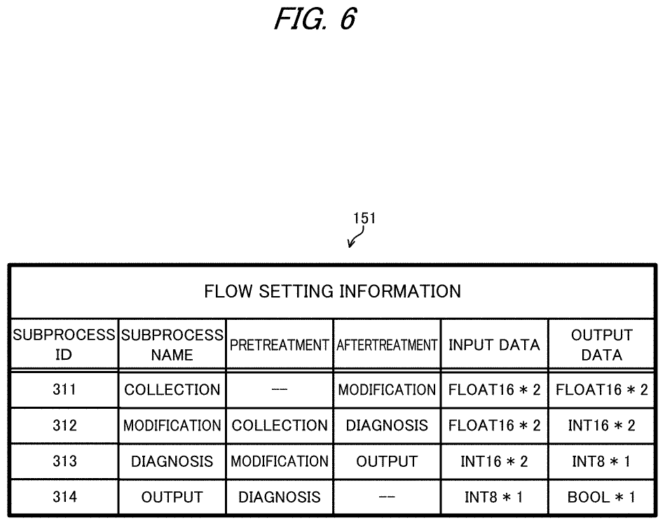

FIG. 6 illustrates an example of flow setting information 151 stored in the storage 15. The flow setting information 151 indicates the setting items necessary for execution of the data processing flow illustrated in FIG. 5. The flow setting information 151 is table data that associates the subprocess identifier (ID) for identifying a certain subprocess, the name of the certain subprocess, the subprocess corresponding to a pretreatment of the certain subprocess, the subprocess corresponding to an aftertreatment of the certain subprocess, the type of data to be input to the certain subprocess, and the type of data to be output from the certain subprocess, with each other. Although FIG. 6 illustrates the names of subprocesses “collection”, “modification”, and “diagnosis” for descriptive purposes, the “modification” includes multiple types of processing, such as averaging and sharpening, for example. The names of subprocesses are thus replaced with the IDs specialized for the individual types of processing in practice. The IDs of subprocesses are also used to designate the pretreatments and aftertreatments.

The flow setting information 151 may contain another information different from the setting items illustrated in FIG. 6. For example, the flow setting information 151 may contain parameters defining the contents of subprocesses. Examples of the parameters include a threshold used in the fraction treatment, an identifier of the machine from which data is collected, a cycle of collecting data, and an identifier of the machine to which control commands are transmitted.

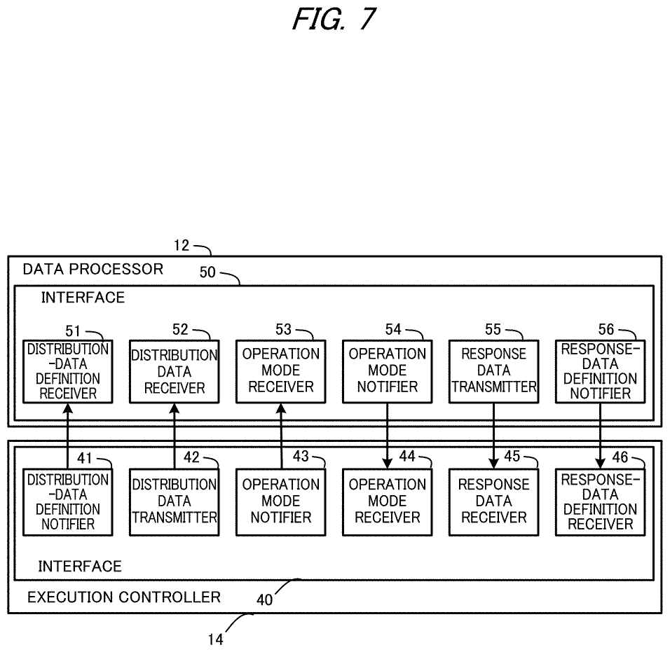

As illustrated in FIG. 7, each of the data processors 12 and the execution controller 14 are equipped with an interface 50 on the side of the data processor 12 and an interface 40 on the side of the execution controller 14, respectively, for transmission and reception of data to and from each other.

The interface 40 on the side of the execution controller 14 includes a distribution-data definition notifier 41 to provide a notification of definition information on distribution data in accordance with the interface, a distribution data transmitter 42 to transmit data, an operation mode notifier 43 to provide a notification of an operation mode of the execution controller 14, an operation mode receiver 44 to receive a notification of an operation mode of the data processor 12, a response data receiver 45 to receive response data from the data processor 12, and a response-data definition receiver 46 to receive definition information on response data from the data processor 12.

The interface 50 on the side of the data processor 12 includes a distribution-data definition receiver 51 to receive the definition information on distribution data from the distribution-data definition notifier 41, a distribution data receiver 52 to receive the distribution data from the distribution data transmitter 42, an operation mode receiver 53 to receive the notification of the operation mode of the execution controller 14, an operation mode notifier 54 to provide the notification of the operation mode of the data processor 12, a response data transmitter 55 to transmit the response data to the response data receiver 45, and a response-data definition notifier 56 to transmit the definition information on response data to the response-data definition receiver 46. The interface 50 is an example of a first interface in the claims, and the interface 40 is an example of a second interface in the claims. The operation mode notifier 54 is an example of a first operation mode notifier in the claims, and the operation mode receiver 44 is an example of a first operation mode receiver in the claims. The operation mode notifier 43 is an example of a second operation mode notifier in the claims, and the operation mode receiver 53 is an example of a second operation mode receiver in the claims.

The distribution data is data to be transmitted from the execution controller 14 to the data processor 12 before being subject to the data processing at the data processor 12. The distribution data is output via the distribution data transmitter 42 from the execution controller 14. The output distribution data is received via the distribution data receiver 52 at the data processor 12.

The definition information on distribution data indicates a format of distribution data. The definition information on distribution data contains, for example, a type of data (data format), name of data, amount of data, array of data, existence of padding data, existence of encryption and encryption scheme, data transmission interval, and data transmission means (for example, file format). In the case of encrypted data, the information related to encryption may contain information that the data is encrypted and information on the encryption scheme, or may contain the information on the encryption scheme alone. In the case of non-encrypted data, the information related to encryption may contain information that the data is not encrypted, or may be excluded from the definition information. The above-mentioned definition information on distribution data is a mere example and does not necessarily contain all of these information items.

The response data is data to be transmitted from the data processor 12 to the execution controller 14 after being subject to the data processing at the data processor 12. The response data is output via the response data transmitter 55 from the data processor 12. The output response data is received via the response data receiver 45 at the execution controller 14.

The definition information on response data indicates a format of response data. The definition information on response data contains, for example, a type of data (data format), name of data, amount of data, array of data, existence of padding data, existence of encryption and encryption scheme, data transmission interval, and data transmission means (for example, file format). In the case of encrypted data, the information related to encryption may contain information that the data is encrypted and information on the encryption scheme, or may contain the information on the encryption scheme alone. In the case of non-encrypted data, the information related to encryption may contain information that the data is not encrypted, or may be excluded from the definition information. The above-mentioned definition information on response data is a mere example and does not necessarily contain all of these information items.

The definition information on distribution data and the definition information on response data correspond to the above-mentioned definition information on the data stored in the storage 15.

The operation mode indicates an operation mode (for example, active mode or stop mode) of the data processor 12 or the execution controller 14. On the basis of the received operation mode, the data processor 12 or the execution controller 14 can determine whether transmission of distribution data or response data is allowed and determine the timing of the transmission.

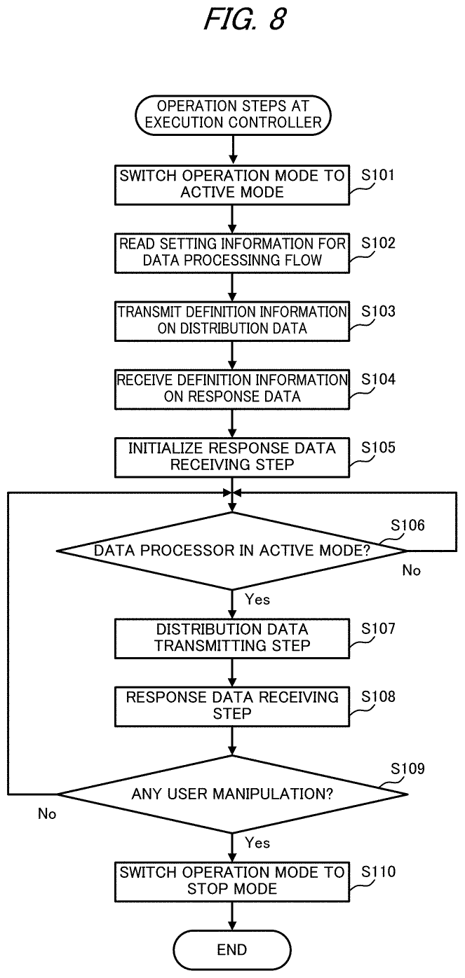

FIG. 8 illustrates operation steps of transmitting and receiving data at the execution controller 14. When the data processing defined in the data processing flow is started in response to a manipulation, such as activation of the system, then the execution controller 14 first switches the own operation mode to the active mode (Step S101).

The execution controller 14 then reads setting information for the data processing flow and specifies the data processor 12 indicated in the setting information (Step S102).

The execution controller 14 then transmits the definition information on distribution data, which is read from the storage 15, to the specified data processor 12 via the distribution-data definition notifier 41 (Step S103).

The execution controller 14 then receives the definition information on response data to be received from the specified data processor 12, from the response-data definition notifier 56 of the data processor 12 (Step S104). In the case where multiple data processors 12 are specified, the transmission of the definition information on distribution data and the reception of the definition information on response data are performed between the execution controller 14 and each of the data processors 12. That is, in the case of multiple specified data processors 12, Steps S103 and S104 are repeated the number of times equal to the number of the specified data processors 12, although the flowchart in FIG. 8 does not refer to the repetition.

After completion of the transmission of the definition information on distribution data and the reception of the definition information on response data, the execution controller 14 initializes the response data receiving step in accordance with the definition information (Step S105).

After completion of the initialization, the execution controller 14 determines whether the specified data processor 12 is in the active mode (Step S106). This determination whether the data processor 12 is in the active mode is conducted on the basis of the notification of the operation mode, which is output from the operation mode notifier 54 of the data processor 12 and received at the operation mode receiver 44 of the execution controller 14.

The operation mode notifier 54 of the data processor 12 outputs notifications of the operation mode at certain time intervals. The step of outputting notifications of the operation mode is executed in parallel to the operation steps illustrated in FIG. 8. The execution controller 14 determines the operation mode on the basis of the notification of the operation mode most recently received at the operation mode receiver 44. In the case where the data processor 12 is in an error state, however, the operation mode notifier 54 may fail to output notifications of the operation mode at certain time intervals. In such a case, when the execution controller 14 determines the operation mode on the basis of the notification of the operation mode most recently received at the operation mode receiver 44, the determination is conducted on the basis of the operation mode before occurrence of an error. The execution controller 14 may thus make an incorrect determination that the data processor 12 is in the active mode, despite of the stop mode of the actual data processor 12 due to the error.

In order to avoid such an incorrect determination, the execution controller 14 may determine an error when no notification of the operation mode has been provided for at least a certain period (for example, 30 seconds).

An error is thus not determined unless the time reaches the certain period or more. The component to provide the notification of the operation mode may therefore vary the interval of the notifications of the operation mode within the range of the certain period depending on the processing load. In an exemplary case of a large processing load, the interval of the notifications of the operation mode is extended substantially as long as the certain period.

If the data processor 12 is not in the active mode, that is, is in the stop mode (Step S106: No), the execution controller 14 repeats Step S106 and waits until the operation mode of the data processor 12 is switched to the active mode. During the stop mode of the data processor 12, the execution controller 14 accumulates the distribution data into a storage in the execution controller 14. When the operation mode of the data processor 12 is switched to the active mode (Step S106: Yes), the execution controller 14 transmits the accumulated distribution data to the data processor 12 (Step S107).

The data processor 12, which receives the distribution data from the execution controller 14, executes data processing on the basis of the distribution data, and transmits data on the result of the data processing in the form of response data back to the execution controller 14. The execution controller 14 receives the response data from the data processor 12 (Step S108), and then determines whether the data processing flow has been interrupted by a user manipulation (Step S109). Examples of the user manipulation include an ON/OFF manipulation of a toggle switch mounted on the data processing device 1 and an ON/OFF manipulation via the engineering tool 13. When the data processing flow has not been interrupted by a user manipulation (Step S109: No), the process returns to Step S106. This step is followed by repetition of the transmission of distribution data and the reception of response data unless the data processing flow is interrupted by a user manipulation. The above-mentioned order of the distribution data transmitting step and the response data receiving step is a mere example. In an exemplary case where the preparation for transmission of subsequent distribution data is completed before the reception of response data, the execution controller 14 executes the subsequent distribution data transmitting step before the response data receiving step.

If the data processing flow has been interrupted by a user manipulation or the like (Step S109: Yes), the execution controller 14 terminates the repetition of the transmission of distribution data and the reception of response data, switches the operation mode to the stop mode (Step S110), and then terminates the operation.

Although the flowchart illustrated in FIG. 8 is related to the transmission and reception of data between the execution controller 14 and the single data processor 12, a data processing flow may involve multiple data processing modules. In the case of two or more data processing modules, the steps other than Steps S101, S102, and S110 are executed the number of times equal to the number of the data processors 12 for the individual data processors 12.

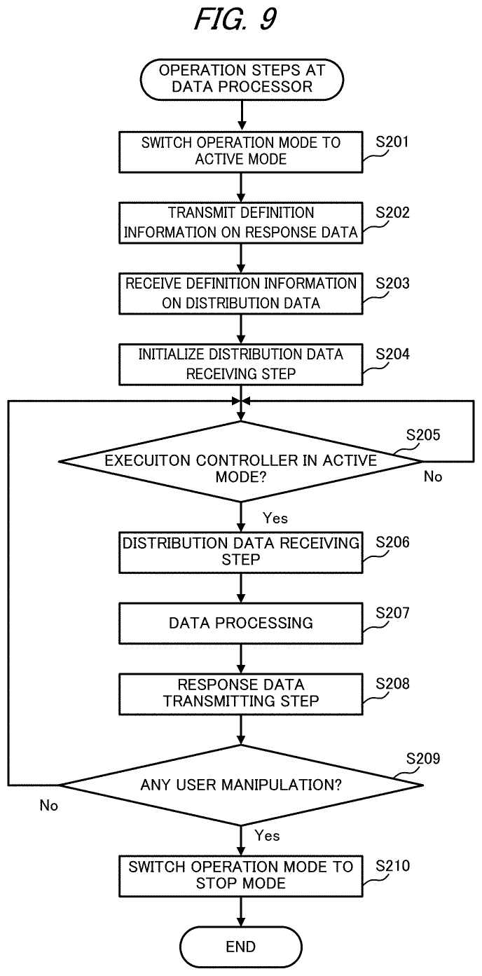

FIG. 9 illustrates operation steps of transmitting and receiving data at the data processor 12. When the data processor 12 is activated by execution of an execution file or manipulation on a start menu, for example, then the data processor 12 first switches the own operation mode to the active mode (Step S201). The data processor 12 then transmits the definition information on response data via the response-data definition notifier 56 to the response-data definition receiver 46 of the execution controller 14, in accordance with the setting of the data processor 12 (Step S202). The distribution-data definition receiver 51 then receives the definition information on distribution data from the distribution-data definition notifier 41 of the execution controller 14 (Step S203). In accordance with the definition information on distribution data, the data processor 12 initializes the distribution data receiving step (Step S204). After completion of the initialization, the data processor 12 determines whether the execution controller 14 is in the active mode (Step S205). The determination whether the execution controller 14 is in the active mode is conducted on the basis of the notification of the operation mode, which is output from the operation mode notifier 43 of the execution controller 14 and received at the operation mode receiver 53 of the data processor 12.

The operation mode notifier 43 of the execution controller 14 outputs notifications of the operation mode at certain time intervals, like the operation mode notifier 54 of the data processor 12. The step of outputting notifications of the operation mode is executed in parallel to the operation steps illustrated in FIG. 9. The data processor 12 determines the operation mode on the basis of the notification of the operation mode most recently received at the operation mode receiver 53. In the case where the execution controller 14 is in an error state, however, the operation mode notifier 43 may fail to output notifications of the operation mode at certain time intervals. In such a case, when the data processor 12 determines the operation mode on the basis of the notification of the operation mode most recently received at the operation mode receiver 53, the determination is conducted on the basis of the operation mode before occurrence of an error. The data processor 12 may thus make an incorrect determination that the execution controller 14 is in the active mode, despite of the stop mode of the actual execution controller 14 due to the error.

In order to avoid such an incorrect determination, the data processor 12 may determine an error when no notification of the operation mode has been provided for at least a certain period (for example, 30 seconds).

In association with this modification, the component to provide the notification of the operation mode may vary the interval of the notifications of the operation mode depending on the processing load.

If the execution controller 14 is not in the active mode, that is, is in the stop mode (Step S205: No), then the data processor 12 repeats Step S205 and waits until the operation mode of the execution controller 14 is switched to the active mode.

If the execution controller 14 is in the active mode (Step S205: Yes), the distribution data receiver 52 of the data processor 12 starts to receive distribution data from the distribution data transmitter 42 of the execution controller 14 (Step S206). The data processor 12, which receives the distribution data from the execution controller 14, executes data processing on the basis of the distribution data (Step S207). After the data processing, the data processor 12 transmits data on the result of the data processing in the form of response data, via the response data transmitter 55 to the response data receiver 45 of the execution controller 14 (Step S208). The data processor 12 then determines whether the data processor 12 has been stopped by a user manipulation (Step S209). Examples of the user manipulation include an ON/OFF manipulation of the toggle switch mounted on the data processing device 1 and an ON/OFF manipulation via the engineering tool 13. When the data processor 12 has not been stopped by a user manipulation (Step S209: No), the process returns to Step S205. This step is followed by repetition of the reception of distribution data, the data processing, and the transmission of response data unless the data processing flow is interrupted by a user manipulation. The above-mentioned order of the distribution data receiving step and the response data transmitting step is a mere example. In an exemplary case where the preparation for reception of subsequent distribution data is completed before the transmission of response data, the data processor 12 executes the subsequent distribution data receiving step before the response data transmitting step.

If the data processor 12 has been stopped by a user manipulation or the like (Step S209: Yes), the data processor 12 terminates the repetition of the distribution data and the transmission of the response data, switches the operation mode to the stop mode (Step S210), and then terminates the operation.

The content of the definition information on distribution data and the content of the definition information on response data are basically not associated with each other. It should be noted that the content of the definition information on distribution data may affect the content of the definition information on response data in some conceivable cases. In such cases, the order of Steps S202 and S203 is reversed.

That is, when the operation mode of the data processor 12 is switched to the active mode, the distribution-data definition receiver 51 of the data processor 12 receives the definition information on distribution data from the execution controller 14. In accordance with the received definition information on distribution data, the data processor 12 generates definition information on response data. The response-data definition notifier 56 of the data processor 12 then transmits the generated definition information on response data to the response-data definition receiver 46 of the execution controller 14. This step is accompanied by Step S204 and the following steps.

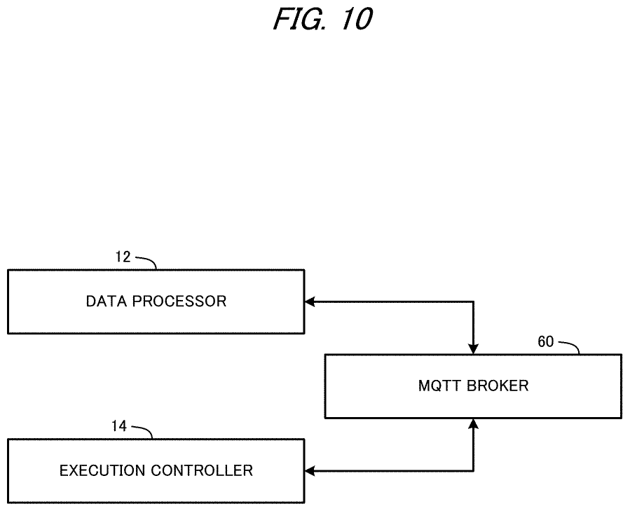

In this system, the transmission and reception of data between the data processors 12 and the execution controller 14 may be conducted via a data distribution server, as illustrated in FIG. 10, instead of direct transmission or reception.

A typical conceivable example of the data distribution server is a message queuing telemetry transport (MQTT) broker 60.

The MQTT is a light-weight communication protocol operating on the transmission control protocol/internet protocol (TCP/IP) and serves to transfer publish/subscribe messages.

In the MQTT communication protocol, a device to transmit MQTT messages is called a publisher, while a device to receive MQTT messages is called a subscriber. The MQTT messages to be transmitted and received between the publisher and the subscriber are relayed by the data distribution server called the MQTT broker 60. The publisher transmits an MQTT message to the MQTT broker 60 without being informed of the details of the subscriber to receive the MQTT message. The MQTT broker 60 receives MQTT messages from publishers and accumulates the MQTT messages, and transmits MQTT messages required by subscribers.

The relay of a message to be transmitted and received uses information for discriminating the destination of the message, which is called a topic.

The subscriber designates a topic and subscribes messages directed to the designated topic.

If the publisher designates a topic and transmits messages, the MQTT broker 60 distributes these massages to subscribers associated with the designated topic.

In this system, definition information on distribution data, distribution data, an operation mode of the data processor 12, an operation mode of the execution controller 14, response data, and definition information on response data can be designated as a topic.

The distribution-data definition receiver 51 of the data processor 12, which is a subscriber, designates the topic of definition information on distribution data and subscribes messages directed to the designated topic.

The distribution data receiver 52 of the data processor 12 designates the topic of distribution data and subscribes messages directed to the designated topic.

The operation mode receiver 53 of the data processor 12 designates the topic of operation mode of the execution controller 14 and subscribes messages directed to the designated topic.

The operation mode receiver 44 of the execution controller 14 designates the topic of operation mode of the data processor 12 and subscribes messages directed to the designated topic.

The response data receiver 45 of the execution controller 14 designates the topic of response data and subscribes messages directed to the designated topic.

The response-data definition receiver 46 of the execution controller 14 designates the topic of definition information on response data and subscribes messages directed to the designated topic.

The distribution-data definition notifier 41 of the execution controller 14, which is a publisher, designates the topic of definition information on distribution data and publishes messages.

The distribution data transmitter 42 of the execution controller 14 designates the topic of distribution data and publishes messages.

The operation mode notifier 54 of the data processor 12 designates the topic of operation mode of the data processor 12 and publishes messages.

The operation mode notifier 43 of the execution controller 14 designates the topic of operation mode of the execution controller 14 and publishes messages.

The response data transmitter 55 of the data processor 12 designates the topic of response data and publishes messages.

The response-data definition notifier 56 of the data processor 12 designates the topic of definition information on response data and publishes messages.

The execution controller 14 converts the definition information on distribution data, the distribution data, and the operation mode of the execution controller 14 into data conforming to the MQTT communication protocol, and then transmits the converted data to the MQTT broker 60 via the network.

The MQTT broker 60 receives the data from the execution controller 14 and transmits the received data to the data processor 12 via the network.

In this situation, the execution controller 14 serves as a publisher, the data processor 12 serves as a subscriber, and the MQTT broker 60 relays MQTT messages from the execution controller 14 to the data processor 12.

Also, the data processor 12 converts the definition information on response data, the response data, and the operation mode of the data processor 12 into data conforming to the MQTT communication protocol, and then transmits the converted data to the MQTT broker 60 via the network.

The MQTT server receives the data from the data processor 12 and transmits the received data to the execution controller 14 via the network.

In this situation, the data processor 12 serves as a publisher, the execution controller 14 serves as a subscriber, and the MQTT broker 60 relays MQTT messages from the data processor 12 to the execution controller 14.

The functions of the data processing device 1 in the above embodiment may be achieved by dedicated hardware or an ordinal computer system.

For example, the program P1 to be executed by the processor 21 may be stored in a non-transitory computer-readable recording medium for distribution and then installed in a computer to configure a device for performing the above-explained processes. Conceivable examples of such a non-transitory recording medium include a flexible disk, a compact disc read-only memory (CD-ROM), a digital versatile disc (DVD), and a magneto-optical disc (MO).

The program P1 may also be stored in a disk drive included in a server apparatus on a communication network, represented by the Internet, and may be downloaded into a computer by being superimposed on a carrier wave, for example.

Alternatively, the program P1 may be activated while being transferred through a communication network to perform the above-explained processes.

A server apparatus may execute all or part of the program P1 and a computer may execute the program P1 while transmitting and receiving information on the executed processes to and from the server apparatus via a communication network, to perform the above-explained processes.

In the case where the above-described functions are achieved by an operating system (OS) or by cooperation of the OS and applications, only the components other than the OS may be stored in a non-transitory medium for distribution or downloaded into a computer, for example.

The functions of the data processing device 1 may also be performed by means other than software. Part or all of the functions may be performed by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The disclosure is widely applicable to data processing devices that execute data processing, such as modification and diagnosis, on collected data.

### REFERENCE SIGNS LIST

100 Data processing system

1 Data processing device

2 Field system

3 Cloud server

4 Machine

11 Data collector

12 Data processor

13 Engineering tool

131 UI

132 Receiver

14 Execution controller

15 Storage

16 Platform

17 Communication path

21 Processor

22 Main storage

23 Auxiliary storage

24 Inputter

25 Outputter

26 Communicator

27 Internal bus

30 Data processing flow

311, 312, 313, 314 Subprocess

151 Flow setting information

40, 50 Interface

41 Distribution-data definition notifier

42 Distribution data transmitter

43, 54 Operation mode notifier

44, 53 Operation mode receiver

45 Response data receiver

46 Response-data definition receiver

51 Distribution-data definition receiver

52 Distribution data receiver

55 Response data transmitter

56 Response-data definition notifier

60 MQTT broker

P1 Program

1. A data processing device comprising:
a data collector to collect data from a machine;
data processors to individually execute predetermined data processing;
an execution controller to control transmission and reception of data between the data collector and each of the data processors, and between the data processors, in accordance with setting information for a predetermined data processing flow;
a first interface provided in each of the data processors; and
a second interface provided in the execution controller, wherein
the first interface comprises:
a distribution data receiver to receive distribution data transmitted from the execution controller in accordance with the setting information for the data processing flow, the distribution data being data before being subject to the data processing at the data processor;
a distribution-data definition receiver to receive definition information on the distribution data that is information indicating a format of the distribution data;
a response data transmitter to transmit response data to the execution controller, the response data being data after being subject to the data processing at the data processor; and
a response-data definition notifier to transmit definition information on the response data that is information indicating a format of the response data, and
the second interface comprises:
a distribution data transmitter to transmit the distribution data;
a distribution-data definition notifier to transmit the definition information on the distribution data;
a response data receiver to receive the response data; and
a response-data definition receiver to receive the definition information on the response data.

2. (canceled)

3. The data processing device according to claim 1, wherein
the first interface further comprises a first operation mode notifier to transmit information indicating an operation mode of the data processor to the execution controller, and
the second interface further comprises a first operation mode receiver to receive the information indicating the operation mode transmitted from the data processor.

4. The data processing device according to claim 1, wherein
the second interface further comprises a second operation mode notifier to transmit information indicating an operation mode of the execution controller to the data processor, and
the first interface further comprises a second operation mode receiver to receive the information indicating the operation mode transmitted from the execution controller.

5. The data processing device according to claim 1, wherein the definition information on the distribution data and the definition information on the response data contain information on a type of the data and an amount of the data.

6. The data processing device according to claim 1, wherein the definition information on the distribution data and the definition information on the response data contain information on an array of the data.

7. The data processing device according to claim 1, wherein the definition information on the distribution data and the definition information on the response data contain information on an encryption scheme when the data is encrypted.

8. The data processing device according to claim 1, wherein
the data collector collects data from an FA machine, and
each of the data processors is achieved by plug-in software for data processing that is modification or diagnosis of the collected data or data on which data processing is performed by another data processor.

9. A data processing method comprising:
reading setting information for a data processing flow;
transmitting definition information on distribution data that is information indicating a format of the distribution data, to a data processor specified by the setting information for the data processing flow, the distribution data being data before being subject to data processing at the data processor;
receiving from the data processor definition information on response data that is information indicating a format of the response data, the response data being data after being subject to the data processing at the data processor;
determining an operation mode of the data processor;
transmitting the distribution data to the data processor; and
initializing a step of receiving response data in accordance with the definition information on the response data and receiving the response data from the data processor.

10. A non-transitory computer readable recording medium storing a program for causing a computer to:
read setting information for a data processing flow;
transmit definition information on distribution data that is information indicating a format of the distribution data, to a data processor specified by the setting information for the data processing flow, the distribution data being data before being subject to data processing at the data processor;
receive from the data processor definition information on response data that is information indicating a format of the response data, the response data being data after being subject to the data processing at the data processor;
determine an operation mode of the data processor;
transmit the distribution data to the data processor; and
initialize a step of receiving response data in accordance with the definition information on the response data and receiving the response data from the data processor.
